(19) United States
(12) Patent Application Publication
(10) Pub. No.: US 2026/0254651 A1
(43) Pub. Date: Aug. 27, 2026

(54) SYSTEMS AND METHODS FOR LINKING METAVERSE IDENTITIES

(71) Applicant: Wells Fargo Bank, N.A., San Francisco, CA (US)

(72) Inventors: Rameshchandra Bhaskar Ketharaju, Hyderabad (IN); Risa Goswami, Puppalguda Telangana (IN)

(21) Appl. No.: 18/172,873

(22) Filed: Feb. 22, 2023

(51) Int. Cl. H04L 9/32

(52) U.S. Cl. CPC H04L 9/3236

(57) ABSTRACT

Systems, apparatuses, methods, and computer program products are disclosed for linking a real-world identity and a metaverse identity. An example method includes receiving an indication of user input from a user avatar, the user input comprising a user identification and a set of input parameters, and verifying, by a distributed application engine, authenticity of the input parameters. The example method further includes generating, by cryptographic circuitry, an authentication hash of hash components, the hash components comprising the set of input parameters, and transmitting the authentication hash to an authentication entity. The example method further includes, in response to transmitting the authentication hash to the authentication entity, receiving customer verification data pertaining to a user associated with the user avatar, and generating, by blockchain circuitry and based on the customer verification data, a block on a distributed ledger, wherein the block comprises the set of input parameters.

### BACKGROUND

Users in the metaverse may wish to conduct various financial transactions, and may be required to link to various details of real-world identities to do so. However, preventing fraudulent transactions is currently difficult due to both the complications of linking these identities and the inability to link multiple identities to a single real-world user.

### BRIEF SUMMARY

The metaverse is growing in importance, with users conducting various activities including purchasing land and property, holding digital concerts, and with organizations setting up branches in the metaverse. With this growing importance, there is an increasing need to link the digital identity of user avatars with real-world users who may conduct financial transactions in the metaverse.

Currently, linking digital avatar identities to real-world identities in a one-to-one manner is difficult. In addition, interoperability between various metaverse instances and lands is an unsettled issue, with no guarantee that a user may be able to transfer a digital identity and the linkage of that identity to a real-world identity between metaverses. Organizations that wish to conduct business in the metaverse do not currently have a way to distinguish or flag multiple transactions coming from the same user. This makes prevention of fraud more difficult in the metaverse.

Example embodiments disclosed herein, in contrast, provide a unique linking between real-world identities and user avatars using distributed ledgers. The unique link works irrespective of the metaverse instance, allowing interoperability between lands and instances, acting as a universal passport in a distributed ledger. This universal passport also takes advantage of the scalability and decentralization of distributed ledger technologies. This universal passport provides a substantial improvement over existing metaverse technologies by solving problems of interoperability and fraud prevention.

Accordingly, the present disclosure sets forth systems, methods, and apparatuses that establish a link connecting a user's real-world identity to a digital identity in a distributed ledger, which identifies the user in a metaverse. The link is created by a distributed application run on the distributed ledger which generates an authentication hash of user identification parameters that may be provided by a user on a metaverse. The distributed application may provide the authentication hash to a trusted authentication entity, such as a bank or vendor, where the authentication hash may be checked against a database of hashes to find the corresponding user records. The distributed application may also create a new block on the distributed ledger that includes the user identification parameters, imported data from the trusted authentication entity such as bank account information, transactions, credit score, or the like, the hash of a parallel layer-1 block on the distributed ledger, and the new authentication hash. This new block may be accessed to link the identity of a user avatar to a real-world identity.

The foregoing brief summary is provided merely for purposes of summarizing some example embodiments described herein. Because the above-described embodiments are merely examples, they should not be construed to narrow the scope of this disclosure in any way. It will be appreciated that the scope of the present disclosure encompasses many potential embodiments in addition to those summarized above, some of which will be described in further detail below.

### BRIEF DESCRIPTION OF THE FIGURES

Having described certain example embodiments in general terms above, reference will now be made to the accompanying drawings, which are not necessarily drawn to scale.

Some embodiments may include fewer or more components than those shown in the figures.

FIG. 1 illustrates a system in which some example embodiments may be used to establish links between real-world and metaverse identities.

FIG. 2 illustrates a schematic block diagram of example circuitry embodying a device that may perform various operations in accordance with some example embodiments described herein.

FIG. 3 illustrates an example depiction of interface layers of a distributed ledger solution for linking a real-world identity to a metaverse identity.

FIG. 4 illustrates an example flowchart for verifying an identity for a user avatar in a metaverse, in accordance with some example embodiments described herein.

FIG. 5 illustrates an example flowchart for authorizing a user in a metaverse, in accordance with some example embodiments described herein.

FIG. 6 illustrates another example flowchart for verifying an identity for a user and authorizing a user in a metaverse, in accordance with some example embodiments described herein.

### DETAILED DESCRIPTION

Some example embodiments will now be described more fully hereinafter with reference to the accompanying figures, in which some, but not necessarily all, embodiments are shown. Because inventions described herein may be embodied in many different forms, the invention should not be limited solely to the embodiments set forth herein; rather, these embodiments are provided so that this disclosure will satisfy applicable legal requirements.

The term “computing device” is used herein to refer to any one or all of programmable logic controllers (PLCs), programmable automation controllers (PACs), industrial computers, desktop computers, personal data assistants (PDAs), laptop computers, tablet computers, smart books, palm-top computers, personal computers, smartphones, wearable devices (such as headsets, smartwatches, or the like), and similar electronic devices equipped with at least a processor and any other physical components necessarily to perform the various operations described herein. Devices such as smartphones, laptop computers, tablet computers, and wearable devices are generally collectively referred to as mobile devices.

The term “server” or “server device” is used to refer to any computing device capable of functioning as a server, such as a master exchange server, web server, mail server, document server, or any other type of server. A server may be a dedicated computing device or a server module (e.g., an application) hosted by a computing device that causes the computing device to operate as a server.

The term “input parameters” refers to a data structure that may include information used to verify the authenticity of a user identifier and/or connect the user identifier to a metaverse identity. In some embodiments, the set of input parameters may include a name of the user avatar, a type of the user identification, a user identification number, a country code, or a combination of the above. The name of the user avatar may be an identifier of a user identity in a metaverse. The name of the user avatar may be unique or may be a user-recognizable non-unique name. The user identification type may indicate the type of identity the user identifier provides. For example, if the user identification links to the user's real-world identity outside of the metaverse, the type of user identification may be a username for a bank account, a government-issued ID number, or the like. The user identification number may be an additional form of user identification if the main user identification is not a user identification number. The country code may identify the user's country of residence or origin, and may provide context for data related to a government-issued ID.

The term “distributed application” refers to software that executes on multiple hosts of a network, and in some embodiments, may require execution on multiple hosts to exploit all the features of the distributed application. The distributed application engine may include a distributed application of a distributed ledger, where the hosts executing the distributed application may be nodes of a distributed ledger. An example of a distributed application on a distributed ledger is provided by the distributed or decentralized applications of the Ethereum blockchain. Ethereum distributed/decentralized applications may run on blockchain nodes and store data on the blockchain. Processing power to execute applications may be allocated using the same or a similar system for allocating standard blockchain transactions (e.g., proof of work, proof of stake, etc.).

The term “customer verification data” refers to protected information that may relate to the user's real-world identity outside of the metaverse, which may not be linked to any user avatar. In some embodiments, the customer verification data may include bank account information, past transaction information, a credit score, or a combination of the above. The customer verification data may be owned or accessible by an authentication entity, and may be stored on a customer database or other storage, which may be maintained by the authentication entity or may be maintained by another entity which grants access to the authentication entity to access customer verification data. The customer verification data may be used by the user, via one of the user avatars, to conduct transactions including purchases, sales, loans, deposits, trades, or other like operations in the metaverse which may require information about the real-world identity of the user.

### System Architecture

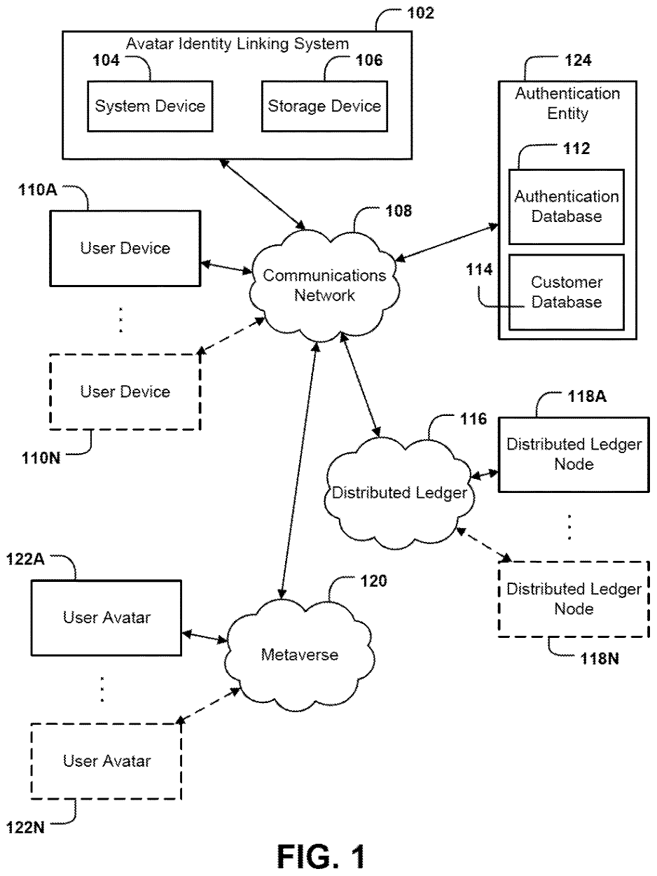

Example embodiments described herein may be implemented using any of a variety of computing devices or servers. To this end, FIG. 1 illustrates an example environment within which various embodiments may operate. As illustrated, an avatar identity linking system 102 may include a system device 104 in communication with a storage device 106. Although system device 104 and storage device 106 are described in singular form, some embodiments may utilize more than one system device 104 and/or more than one storage device 106. Additionally, some embodiments of the avatar identity linking system 102 may not require a storage device 106 at all. Whatever the implementation, the avatar identity linking system 102, and its constituent system device(s) 104 and/or storage device(s) 106 may receive and/or transmit information via communications network 108 (e.g., the Internet) with any number of other devices, such as one or more of user device 110A, through user device 110N, distributed ledger node 118A through distributed ledger node 118N, authentication entity 124, authentication database 112, customer database 114, and/or user avatar 122A, through user avatar 122N.

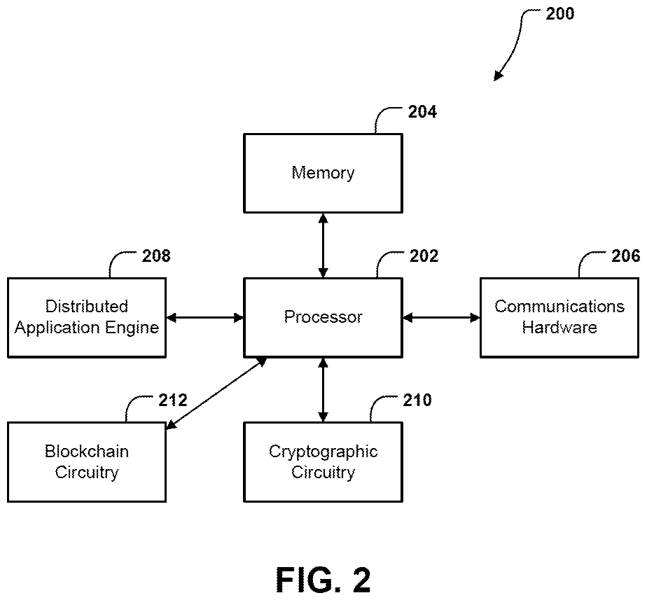

System device 104 may be implemented as one or more servers, which may or may not be physically proximate to other components of avatar identity linking system 102. Furthermore, some components of system device 104 may be physically proximate to the other components of avatar identity linking system 102 while other components are not. System device 104 may receive, process, generate, and transmit data, signals, and electronic information to facilitate the operations of the avatar identity linking system 102. Particular components of system device 104 are described in greater detail below with reference to apparatus 200 in connection with FIG. 2.

Storage device 106 may comprise a distinct component from system device 104, or may comprise an element of system device 104 (e.g., memory 204, as described below in connection with FIG. 2). Storage device 106 may be embodied as one or more direct-attached storage (DAS) devices (such as hard drives, solid-state drives, optical disc drives, or the like) or may alternatively comprise one or more Network Attached Storage (NAS) devices independently connected to a communications network (e.g., communications network 108). Storage device 106 may host the software executed to operate the avatar identity linking system 102. Storage device 106 may store information relied upon during operation of the avatar identity linking system 102, such as various records or other files that may be used by the avatar identity linking system 102, data and documents to be analyzed using the avatar identity linking system 102, or the like. In addition, storage device 106 may store control signals, device characteristics, and access credentials enabling interaction between the avatar identity linking system 102 and one or more of the user devices 110A-110N other connected devices.

The one or more user devices 110A-110N may be embodied by any computing devices known in the art. Similarly, the one or more distributed ledger nodes 118A-118N, may be embodied by any computing devices known in the art, such as desktop or laptop computers, tablet devices, smartphones, or the like. The one or more user devices 110A-110N and the one or more distributed ledger nodes 118A-118N need not themselves be independent devices, but may be peripheral devices communicatively coupled to other computing devices.

The authentication entity 124 may also be embodied by any computing devices known in the art, and may not be an independent device but may be a service provided by one or more servers accessible by communications network 108. The authentication database 112 and customer database 114 may be embodied by any storage devices known in the art, and may also be attached devices of the authentication entity, or may be independent devices accessible through a local network by the authenticating network, or may be accessible directly via the communications network 108.

The distributed ledger 116 may be embodied as a collection of networked distributed ledger nodes 118A-118N of a blockchain, which may be permissionless (public), or permissioned (private). The distributed ledger 116 may use any distributed ledger or blockchain technology that is capable of creating and exchanging blockchain tokens or NFTs. In some embodiments, the distributed ledger 116 may allow for Turing-complete scripting of contracts, known also as smart contracts, distributed applications, or decentralized applications, to be executed on the blockchain. The distributed ledger 116 may be related to other blockchain networks not pictured here. For example, the distributed ledger 116 may be a sidechain of another blockchain network, or another network (not shown) may form a sidechain of the distributed ledger 116. The nodes may be embodied by specialized node devices, or may be embodied by any computing devices or server devices known in the art. In some embodiments the avatar identity linking system 102 itself may be a node of the distributed ledger 116, or the avatar identity linking system 102 may be external to the blockchain.

The metaverse 120 may be embodied as a server or collection of servers that provide a virtual world for users to interact with, including activities such as buying and selling services, and may interface with decentralized applications such as a distributed ledger 116 to track or enable certain functionality. User identities may be embodied as one or more user avatars 122A through 122N, which may be virtual identities served by the one or more physical devices embodying the metaverse 120, or may be embodied in separate devices. User avatars may have certain user-defined features such as appearance, language settings, and the like, that mediate the interaction of users on the metaverse 120.

Although FIG. 1 illustrates an environment and implementation in which the avatar identity linking system 102 interacts with one or more of user device 110A, through user device 110N and/or one or more user avatar 122A through user avatar 122N, in some embodiments users may directly interact with the avatar identity linking system 102 (e.g., via input/output circuitry of system device 104), in which case a separate user device 110 or user avatar 122 may not be utilized. Whether by way of direct interaction or via a separate user device 110 or user avatar 122, a user may communicate with, operate, control, modify, or otherwise interact with the avatar identity linking system 102 to perform the various functions and achieve the various benefits described herein.

### Example Implementing Apparatuses

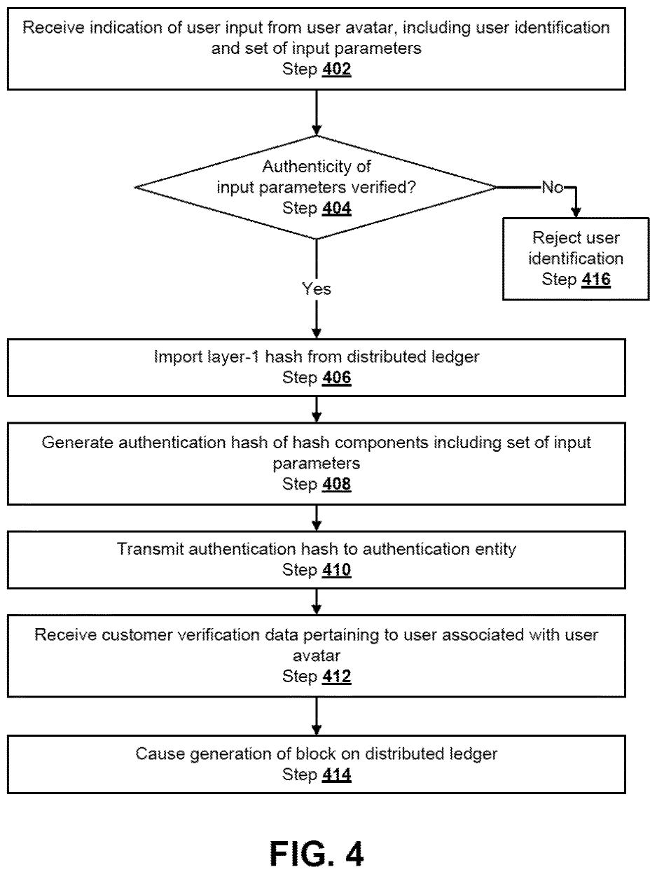

System device 104 of the avatar identity linking system 102 (described previously with reference to FIG. 1) may be embodied by one or more computing devices or servers, shown as apparatus 200 in FIG. 2. As illustrated in FIG. 2, the apparatus 200 may include processor 202, memory 204, communications hardware 206, distributed application engine 208, cryptographic circuitry 210, and blockchain circuitry 212, each of which will be described in greater detail below. While the various components are only illustrated in FIG. 2 as being connected with processor 202, it will be understood that the apparatus 200 may further comprise a bus (not expressly shown in FIG. 2) for passing information amongst any combination of the various components of the apparatus 200. The apparatus 200 may be configured to execute various operations described above in connection with FIG. 1 and below in connection with FIGS. 4-6.

The processor 202 (and/or co-processor or any other processor assisting or otherwise associated with the processor) may be in communication with the memory 204 via a bus for passing information amongst components of the apparatus. The processor 202 may be embodied in a number of different ways and may, for example, include one or more processing devices configured to perform independently. Furthermore, the processor may include one or more processors configured in tandem via a bus to enable independent execution of software instructions, pipelining, and/or multithreading. The use of the term “processor” may be understood to include a single core processor, a multi-core processor, multiple processors of the apparatus 200, remote or “cloud” processors, or any combination thereof.

The processor 202 may be configured to execute software instructions stored in the memory 204 or otherwise accessible to the processor (e.g., software instructions stored on a separate storage device 106, as illustrated in FIG. 1). In some cases, the processor may be configured to execute hard-coded functionality. As such, whether configured by hardware or software methods, or by a combination of hardware with software, the processor 202 represent an entity (e.g., physically embodied in circuitry) capable of performing operations according to various embodiments of the present invention while configured accordingly. Alternatively, as another example, when the processor 202 is embodied as an executor of software instructions, the software instructions may specifically configure the processor 202 to perform the algorithms and/or operations described herein when the software instructions are executed.

Memory 204 is non-transitory and may include, for example, one or more volatile and/or non-volatile memories. In other words, for example, the memory 204 may be an electronic storage device (e.g., a computer readable storage medium). The memory 204 may be configured to store information, data, content, applications, software instructions, or the like, for enabling the apparatus to carry out various functions in accordance with example embodiments contemplated herein.

The communications hardware 206 may be any means such as a device or circuitry embodied in either hardware or a combination of hardware and software that is configured to receive and/or transmit data from/to a network and/or any other device, circuitry, or module in communication with the apparatus 200. In this regard, the communications hardware 206 may include, for example, a network interface for enabling communications with a wired or wireless communication network. For example, the communications hardware 206 may include one or more network interface cards, antennas, buses, switches, routers, modems, and supporting hardware and/or software, or any other device suitable for enabling communications via a network. Furthermore, the communications hardware 206 may include the processing circuitry for causing transmission of such signals to a network or for handling receipt of signals received from a network.

The communications hardware 206 may further be configured to provide output to a user and, in some embodiments, to receive an indication of user input. In this regard, the communications hardware 206 may comprise a user interface, such as a display, and may further comprise the components that govern use of the user interface, such as a web browser, mobile application, dedicated client device, or the like. In some embodiments, the communications hardware 206 may include a keyboard, a mouse, a touch screen, touch areas, soft keys, a microphone, a speaker, and/or other input/output mechanisms. The communications hardware 206 may utilize the processor 202 to control one or more functions of one or more of these user interface elements through software instructions (e.g., application software and/or system software, such as firmware) stored on a memory (e.g., memory 204) accessible to the processor 202.

In addition, the apparatus 200 further comprises a distributed application engine 208 that performs actions involving distributed/decentralized applications on a distributed ledger 116. The distributed application engine 208 may utilize processor 202, memory 204, or any other hardware component included in the apparatus 200 to perform these operations, as described in connection with FIGS. 4-6 below. The distributed application engine 208 may further utilize communications hardware 206 to gather data from a variety of sources (e.g., user device 110A through user device110N or storage device 106, as shown in FIG. 1), and/or exchange data with a user, and in some embodiments may utilize processor 202 and/or memory 204 to manipulate distributed/decentralized applications.

In addition, the apparatus 200 further comprises a cryptographic circuitry 210 that performs cryptographic operations such as encrypting, signing, and the like. The cryptographic circuitry 210 may utilize processor 202, memory 204, or any other hardware component included in the apparatus 200 to perform these operations, as described in connection with FIGS. 4-6 below. The cryptographic circuitry 210 may further utilize communications hardware 206 to gather data from a variety of sources (e.g., user device 110A through user device 110N or storage device 106, as shown in FIG. 1), and/or exchange data with a user, and in some embodiments may utilize processor 202 and/or memory 204 to perform cryptographic operations.

In addition, the apparatus 200 further comprises a blockchain circuitry 212 that broadcasts the creation of blocks and performs other operations on a blockchain or distributed ledger. The blockchain circuitry 212 may utilize processor 202, memory 204, or any other hardware component included in the apparatus 200 to perform these operations, as described in connection with FIGS. 4-6 below. The blockchain circuitry 212 may further utilize communications hardware 206 to gather data from a variety of sources (e.g., user device 110A through user device 110N or storage device 106, as shown in FIG. 1), and/or exchange data with a user, and in some embodiments may utilize processor 202 and/or memory 204 to perform distributed ledger operations.

Although components 202-212 are described in part using functional language, it will be understood that the particular implementations necessarily include the use of particular hardware. It should also be understood that certain of these components 202-212 may include similar or common hardware. For example, the distributed application engine 208, cryptographic circuitry 210, and blockchain circuitry 212 may each at times leverage use of the processor 202, memory 204, or communications hardware 206, such that duplicate hardware is not required to facilitate operation of these physical elements of the apparatus 200 (although dedicated hardware elements may be used for any of these components in some embodiments, such as those in which enhanced parallelism may be desired). Use of the terms “circuitry,” and “engine” with respect to elements of the apparatus therefore shall be interpreted as necessarily including the particular hardware configured to perform the functions associated with the particular element being described. Of course, while the terms “circuitry” and “engine” should be understood broadly to include hardware, in some embodiments, the terms “circuitry” and “engine” may in addition refer to software instructions that configure the hardware components of the apparatus 200 to perform the various functions described herein.

Although the distributed application engine 208, cryptographic circuitry 210, and blockchain circuitry 212 may leverage processor 202, memory 204, or communications hardware 206 as described above, it will be understood that any of these elements of apparatus 200 may include one or more dedicated processor, specially configured field programmable gate array (FPGA), or application specific interface circuit (ASIC) to perform its corresponding functions, and may accordingly leverage processor 202 executing software stored in a memory (e.g., memory 204), or memory 204, or communications hardware 206 for enabling any functions not performed by special-purpose hardware elements. In all embodiments, however, it will be understood that the distributed application engine 208, cryptographic circuitry 210, and blockchain circuitry 212 are implemented via particular machinery designed for performing the functions described herein in connection with such elements of apparatus 200.

In some embodiments, various components of the apparatus 200 may be hosted remotely (e.g., by one or more cloud servers) and thus need not physically reside on the corresponding apparatus 200. Thus, some or all of the functionality described herein may be provided by third party circuitry. For example, a given apparatus 200 may access one or more third party circuitries via any sort of networked connection that facilitates transmission of data and electronic information between the apparatus 200 and the third-party circuitries. In turn, that apparatus 200 may be in remote communication with one or more of the other components describe above as comprising the apparatus 200.

As will be appreciated based on this disclosure, example embodiments contemplated herein may be implemented by an apparatus 200. Furthermore, some example embodiments may take the form of a computer program product comprising software instructions stored on at least one non-transitory computer-readable storage medium (e.g., memory 204). Any suitable non-transitory computer-readable storage medium may be utilized in such embodiments, some examples of which are non-transitory hard disks, CD-ROMs, flash memory, optical storage devices, and magnetic storage devices. It should be appreciated, with respect to certain devices embodied by apparatus 200 as described in FIG. 2, that loading the software instructions onto a computing device or apparatus produces a special-purpose machine comprising the means for implementing various functions described herein.

Having described specific components of example apparatus 200, example embodiments are described below in connection with a series of diagrams and flowcharts.

### Example Operations

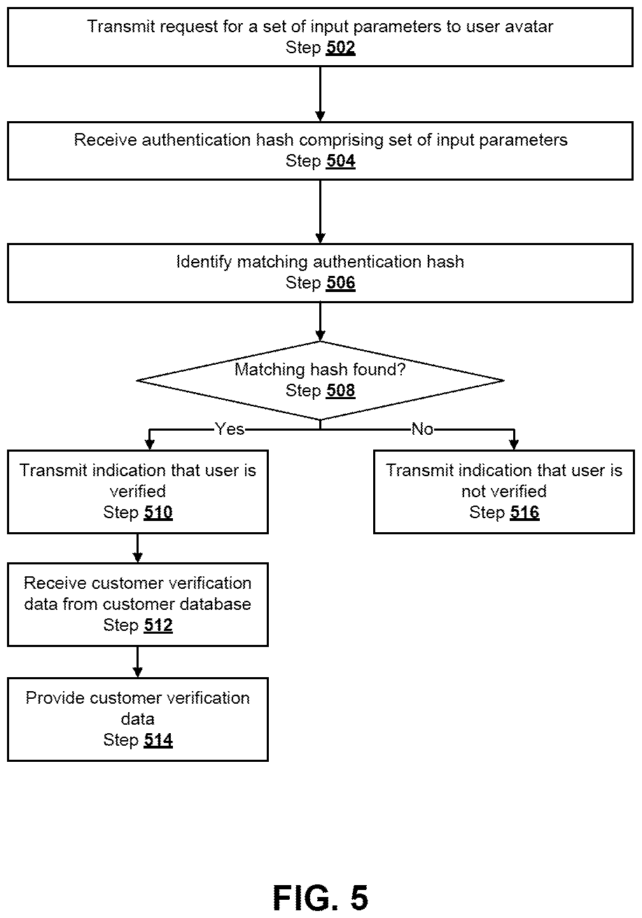

Turning to FIGS. 4 and 5, example flowcharts are illustrated that contain example operations implemented by example embodiments described herein. The operations illustrated in FIGS. 4 and 5 may, for example, be performed by system device 104 of the avatar identity linking system 102 shown in FIG. 1, which may in turn be embodied by an apparatus 200, which is shown and described in connection with FIG. 2. To perform the operations described below, the apparatus 200 may utilize one or more of processor 202, memory 204, communications hardware 206, distributed application engine 208, cryptographic circuitry 210, blockchain circuitry 212, and/or any combination thereof. It will be understood that user interaction with the avatar identity linking system 102 may occur directly via communications hardware 206, or may instead be facilitated by a separate user device 110, as shown in FIG. 1, and which may have similar or equivalent physical componentry facilitating such user interaction.

Turning first to FIG. 4, example operations are shown for verifying an identity for a user avatar in a metaverse 120. As shown by operation 402, the apparatus 200 includes means, such as processor 202, communications hardware 206, or the like, for receiving an indication of user input from a user avatar (e.g., one of user avatars 122A-122N that exist within metaverse 120), where the user input includes a user identification and a set of input parameters. The user input may be received via the communications hardware 206 directly by the avatar identity linking system 102, or from one of user device 110A-110N transmitted over communications network 108. The processor 202 may interpret the user input to determine the user identification and the set of input parameters from the raw input. The user identification may be a string, such as a username entered manually by a user, or the user identification may be another data type that uniquely identifies the user, that may either be manually entered by the user or automatically transmitted after being recorded on the user's device. In some embodiments, a serial number or other unique hardware address of the user's device may be used as the user identification. The user identification may be connected to the user's real identity outside of the metaverse 120, for example, by connecting to a bank account or other service associated with the user's real identity.

The set of input parameters may include additional information that may be used to verify the authenticity of the user identifier and/or connect the user identifier to a metaverse identity. In some embodiments, the set of input parameters may include a name of the user avatar, a type of the user identification, a user identification number, a country code, or a combination of the above. The name of the user avatar may be an identifier of a user identity in a metaverse. The name of the user avatar may be unique or may be a user-recognizable non-unique name. The user identification type may indicate the type of identity the user identifier (described previously) provides. For example, if the user identification links to the user's real-world identity outside of the metaverse, the type of user identification may be a username for a bank account, a government-issued ID number, or the like. The user identification number may be an additional form of user identification if the main user identification is not a user identification number. The country code may identify the user's country of residence or origin, and may provide context for data related to a government-issued ID.

As shown by operation 404, the apparatus 200 includes means, such as distributed application engine 208, or the like, for verifying authenticity of the input parameters. The distributed application engine 208 may verify the authenticity of the input parameters in combination with the user identification provided in connection with operation 402. In some embodiments, the distributed application engine 208 may perform an authentication or verification procedure to verify the user identification corresponds to the user's real identity. For example, the distributed application engine 208 may initiate a challenge-response authentication, password authentication, multi-factor authentication, biometric authentication, knowledge-based authentication, ownership-based authentication, location-based authentication, or any other method for verifying the authenticity of the provided input parameters with the provided user identification.

In some embodiments, the distributed application engine 208 includes a distributed application of the distributed ledger 116. A distributed application may be software that executes on multiple hosts of a network, and in some embodiments, may require execution on multiple hosts to exploit all of the features of the distributed application. The distributed application engine may include a distributed application of a distributed ledger 116, where the hosts executing the distributed application may be distributed ledger nodes 118A-118N of a distributed ledger 116. An example of a distributed application on a distributed ledger 116 is provided by the distributed or decentralized applications of the Ethereum blockchain. Ethereum distributed/decentralized applications may run on blockchain nodes and store data on the blockchain. Processing power to execute applications may be allocated using the same or a similar system for allocating standard blockchain transactions (e.g., proof of work, proof of stake, etc.).

As seen in FIG. 4, control may continue to operation 406 in the event that the distributed application engine 208 successfully verifies the authenticity of the input parameters, or control may pass to operation 416 in the event that the distributed application engine 208 does not successfully verifies the authenticity of the input parameters.

As shown by operation 406, the apparatus 200 includes means, such as communications hardware 206, distributed application engine 208, or the like, for importing the layer-1 hash from the distributed ledger 116. The layer-1 hash may be the hash provided by the base algorithm of the distributed ledger 116. For example, the hash provided by the Bitcoin, Ethereum, or other blockchain networks may be a layer-1 hash. The layer-1 hash may be imported from a distributed ledger 116 and/or blockchain network associated with the metaverse on which the user operates. The layer-1 hash may be imported from a particular block on the blockchain, for example, the block associated with a transaction of currency that may be authorized for a transaction on the metaverse 120. The distributed application engine 208 may cache the layer-1 hash in advance for use in operation 406, or may access, via communications hardware 206 on-demand, via the communications network 108 in communication with the distributed ledger 116.

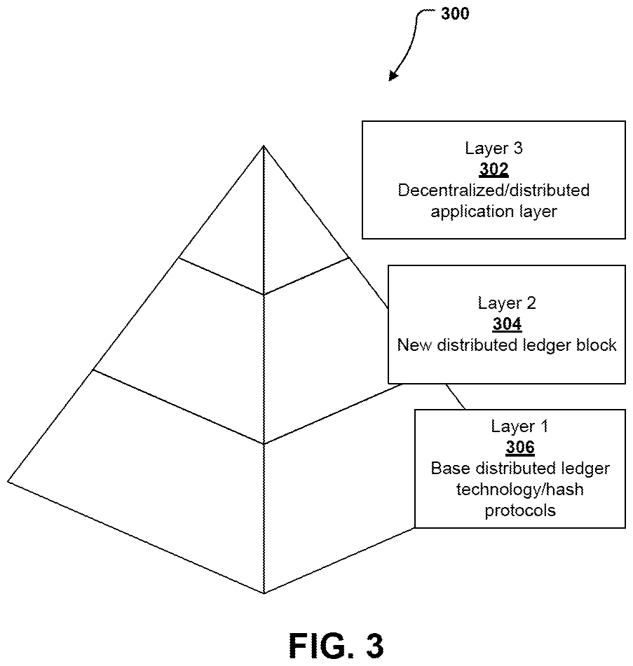

Turning now to FIG. 3, an example diagram is shown depicting the layered design solution 300 for the avatar identity linking system 102. The lowest, or base layer 306 is layer 1. Layer 1 describes the existing infrastructure of the distributed ledger, including the hash protocols, nodes, communication protocols, blocks, linkage of blocks, and other basic technologies on distributed ledger systems. On top of layer 1 is the middle layer 304, or layer 2, which includes the new distributed ledger block, described in detail below in connection with operation 414. The layer 2 components depend on and extend the layer 1 technology. Above layer 2 is the top layer 302, or layer 3. Layer 3 includes the distributed/decentralized application layer, including the applications of the distributed application engine 208. The distributed/decentralized applications make use of, depend on, and extend the functionality of the layer 2 technologies.

Returning now to FIG. 4, as shown by operation 408, the apparatus 200 includes means, such as cryptographic circuitry 210, or the like, for generating an authentication hash of hash components, where the hash components include the set of input parameters. The cryptographic circuitry 210 may generate the authentication hash by initially processing the hash components in a pre-determined manner, for example, by converting each hash component to numerical form, concatenating the hash components, removing formatting or empty fields from the hash components, and/or a combination thereof.

In some embodiments, the hash components further include a layer-1 hash provided by the distributed ledger 116. The layer-1 hash may be imported, for example, from operation 406, described previously. The layer-1 hash may be included in the hash components such that the authentication hash itself is a cryptographic hash of a cryptographic hash, effectively linking the authentication hash to the layer-1 hash. The linking of the authentication hash to the layer-1 hash may create a blockchain link to the layer-1 structure.

The cryptographic circuitry 210 may use any of a number of hashing algorithms to create a secure cryptographic hash of the hash components. The cryptographic hash may be a function that produces an output that a potential attacker cannot use to determine the original hash components. In some embodiments, the authentication hash is generated using a SHA-1 algorithm. The authentication hash may be a unique value that may be generated by other systems that possess the original hash components.

As shown by operation 410, the apparatus 200 includes means, such as communications hardware 206, or the like, for transmitting the authentication hash to an authentication entity. The authentication hash may be transmitted via the communications hardware 206 directly by the avatar identity linking system 102 and to the authentication entity 124 by means of the communications network 108. The authentication entity 124 (described previously in connection with FIG. 1) may have access to or maintain an authentication database 112 with which to compare the authentication hash. The authentication entity 124 may be a computing device or server, a virtual host, or a collection of servers or other devices providing the authenticating service.

As shown by operation 412, the apparatus 200 includes means, such as communications hardware 206, or the like, for, in response to transmitting the authentication hash to the authentication entity 124, receiving customer verification data pertaining to a user associated with the user avatar.

The customer verification data may be protected information that relates to the user's real-world identity outside of the metaverse 120, which may not be linked to any of the user avatars 122A-122N. In some embodiments, the customer verification data may include bank account information, past transaction information, a credit score, or a combination of the above. The customer verification data may be owned or accessible by the authentication entity 124, and may be stored on a customer database 114 or other storage, which may be maintained by the authentication entity 124, or may be maintained by another entity which grants access to the authentication entity 124 to access customer verification data. The customer verification data may be used by the user, via one of the user avatars 122A-122N, to conduct transactions including purchases, sales, loans, deposits, trades, or other like operations in the metaverse 120 which may require information about the real-world identity of the user.

The customer verification data may be received via the communications hardware 206 directly by the avatar identity linking system 102. The customer verification data may be received in response to transmitting the authentication hash to the authentication entity 124, and may be received from the authentication entity 124, or from other remote devices (such as one of the user devices 110A-110N or other remote hosts via the communications network 108) depending on the configuration of the avatar identity linking system 102.

As shown by operation 414, the apparatus 200 includes means, such as communications hardware 206, cryptographic circuitry 210, blockchain circuitry 212, or the like, for causing, based on the customer verification data, generation of a block on a distributed ledger 116, where the block includes the set of input parameters. The blockchain circuitry 212 may direct the communications hardware 206 to broadcast, over the distributed ledger 116, a data structure that may cause the creation of the block on distributed ledger nodes 118A-118N of the distributed ledger 116. The transmission causing the creation of the block may be digitally signed, via cryptographic circuitry 210. The communications hardware 206 may broadcast the block creation over the distributed ledger 116 to cause the block creation to take effect on the blockchain embodied by distributed ledger 116. Broadcasting may enable distributed ledger nodes 118A-118N of the distributed ledger 116 to validate and record the new block. The block may be generated on a layer-2 structure of the distributed ledger 116, such that access to the block contents is restricted to privileged accounts.

The block may include the set of input parameters received in operation 402. In some embodiments, the block also includes the customer verification data. In some embodiments, the block also includes the layer-1 hash provided by the distributed ledger 116. In some embodiments, the block may be generated on a layer-2 structure of the distributed ledger 116, and the layer-1 hash contained in the block may link the layer-2 structure of layer-2 blocks to the layer-1 of the distributed ledger 116.

As shown by operation 416, the apparatus 200 includes means, such as communications hardware 206, or the like, for rejecting the user identification. In the event that the input parameters are rejected as not authentic or invalid, the communications hardware 206 may indicate to the user that the user identification is rejected. For example, the user device 110A may display to the user that a login was invalid due to an invalid user identification, country code, government-issued ID, or other input parameters provided, and may redirect the user to re-enter the invalid information or take other appropriate measures.

Turning next to FIG. 5, example operations are shown for authorizing a user avatar 122A in a metaverse 120. As shown by operation 502, the apparatus 200 includes means, such as communications hardware 206, or the like, for transmitting, to a user avatar, a request for a set of input parameters. The request for the set of input parameters may be transmitted via the communications hardware 206 directly by the avatar identity linking system 102 and to one of the user avatars 122A-122N (on the metaverse 120) by means of the communications network 108. The user avatars 122A-122N (described previously in connection with FIG. 1) may be linked to one or more user devices 110A-110N, which may act as a neutral device or terminal for the user to control one or more of the user avatars 112A-122N.

The set of input parameters may include additional information that may be used to verify the authenticity of the user identifier and/or connect the user identifier to an identity or user avatar 122A through user avatar 122N in a metaverse 120. In some embodiments, the set of input parameters may include a name of the user avatar, a type of the user identification, a user identification number, a country code, or a combination of the above. The name of the user avatar may be an identifier of a user identity or user avatar 122A in a metaverse 120. The name of the user avatar may be unique or may be a user-recognizable non-unique name. The user identification type may indicate the type of identity the user identifier (described previously) provides. For example, if the user identification links to the user's real-world identity outside of the metaverse, the type of user identification may be a username for a bank account, a government-issued ID number, or the like. The user identification number may be an additional form of user identification if the main user identification is not a user identification number. The country code may identify the user's country of residence or origin, and may provide context for data related to a government-issued ID.

As shown by operation 504, the apparatus 200 includes means, such as communications hardware 206, or the like, for receiving an authentication hash of hash components, where the hash components include the set of input parameters. The authentication hash may be received via the communications hardware 206 directly by the avatar identity linking system 102, or from one of user device 110A-110N transmitted over communications network 108. The processor 202 may interpret the authentication hash to validate the authentication hash, for example by checking the length of the authentication hash.

In some embodiments, the hash components further include a layer-1 hash provided by the distributed ledger 116. The layer-1 hash may be included in the hash components such that the authentication hash itself is a cryptographic hash of a cryptographic hash, effectively linking the authentication hash to the layer-1 hash. The linking of the authentication hash to the layer-1 hash may create a blockchain link to the layer-1 structure.

The authentication hash may be generated by any of a number of hashing algorithms to create a secure cryptographic hash of the hash components. The cryptographic hash may be a function that produces an output that a potential attacker cannot use to determine the original hash components. In some embodiments, the authentication hash is generated using a SHA-1 algorithm. The authentication hash may be a unique value that may be generated by other systems that possess the original hash components.

As shown by operation 506, the apparatus 200 includes means, such as distributed application engine 208, or the like, for identifying a matching authentication hash, where the matching authentication hash matches the authentication hash. In some embodiments, the distributed application engine 208 may search an authentication database 112 for the matching authentication hatch. The distributed application engine 208 may utilize the authentication entity 124 to access the authentication database 112, or may directly access the authentication database 112 to retrieve the matching authentication hash. The matching authentication hash may be identical to the authentication hash received in connection with operation 504.

In some embodiments, the distributed application engine 208 includes a distributed application of the distributed ledger 116. A distributed application may be software that executes on multiple hosts of a network, and in some embodiments, may require execution on multiple hosts to exploit all of the features of the distributed application. The distributed application engine may include a distributed application of a distributed ledger 116, where the hosts executing the distributed application may be distributed ledger nodes 118A-118N of a distributed ledger 116. An example of a distributed application on a distributed ledger 116 is provided by the distributed or decentralized applications of the Ethereum blockchain. Ethereum distributed/decentralized applications may run on blockchain nodes and store data on the blockchain. Processing power to execute applications may be allocated using the same or a similar system for allocating standard blockchain transactions (e.g., proof of work, proof of stake, etc.).

As shown by operation 508, control may pass to operation 510 if the authentication hash is found, and to operation 516 if the authentication hash is not found.

As shown by operation 510, the apparatus 200 includes means, such as communications hardware 206, or the like, for, in an instance in which the matching authentication hash is found, transmitting an indication that the user is verified. The communications hardware 206 may transmit the indication to one of the user devices 110A-110N, and/or may cause one or more of the user avatars 122A-122N to indicate to the user that the user is verified.

As shown by operation 512, the apparatus 200 includes means, such as communications hardware 206, or the like, for receiving, from a customer database 114, customer verification data pertaining to a user associated with the user avatar (such as one of the user avatars 122A-122N). The communications hardware 206 may receive the customer verification data in response to the verification of the user from matching the authentication hash, described above in connection with operation 506 through operation 510.

The customer verification data may be protected information that relates to the user's real-world identity outside of the metaverse 120, which may not be linked to any of the user avatars 122A-122N. In some embodiments, the customer verification data may include bank account information, past transaction information, a credit score, or a combination of the above. The customer verification data may be owned or accessible by the authentication entity 124, and may be stored on a customer database 114 or other storage, which may be maintained by the authentication entity 124, or may be maintained by another entity which grants access to the authentication entity 124 to access customer verification data. The customer verification data may be used by the user, via one of the user avatars 122A-122N, to conduct transactions including purchases, sales, loans, deposits, trades, or other like operations in the metaverse 120 which may require information about the real-world identity of the user.

As shown by operation 514, the apparatus 200 includes means, such as communications hardware 206, or the like, for providing the customer verification data. The customer verification data (described previously in connection with operation 512) may be provided directly by the communications hardware 206 of the avatar identity linking system 102. The communications hardware 206 may transmit the customer verification data via the communications network 108 to the metaverse 120. In some embodiments, the customer verification data may be provided to a vendor or financial institution, for example, to validate a financial transaction. The customer verification data may additionally or alternatively be provided to one or more distributed ledger nodes 118A-118N of the distributed ledger 116 to create a block, as described previously in connection with operation 414. In some embodiments, providing the customer verification data to one of the user avatars 122A-122N may complete the user avatar linking method and permit the user to link real-world identity information, such as bank account or spending information, to the user avatar 122A.

As shown by operation 516, the apparatus 200 includes means, such as communications hardware 206, or the like, for, in an instance in which the matching authentication hash is not found, transmitting an indication that the user is not verified. In the event that the matching authentication hash is not found, the authentication hash may be rejected as not authentic or invalid, and the communications hardware 206 may indicate to the user that the authentication hash is. For example, the user device 110A may display to the user that a login was invalid due to a corrupted or improperly prepared hash, or due to invalid data provided in the hash components, such as one of the input parameters.

The flowchart blocks support combinations of means for performing the specified functions and combinations of operations for performing the specified functions. It will be understood that individual flowchart blocks, and/or combinations of flowchart blocks, can be implemented by special purpose hardware-based computing devices which perform the specified functions, or combinations of special purpose hardware and software instructions.

### Example System Interaction

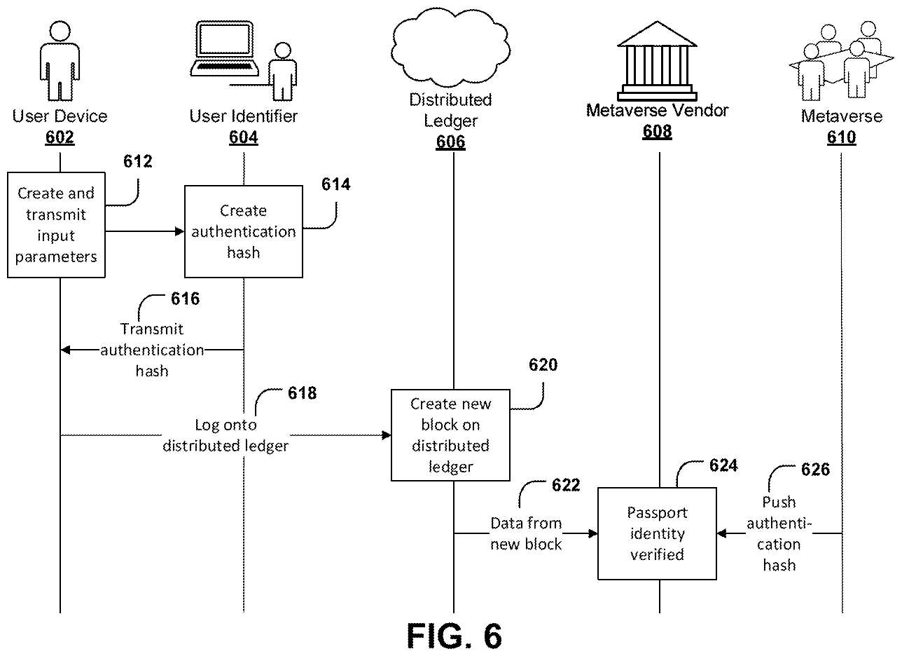

FIG. 6 shows a swim lane diagram illustrating example operations (e.g., as described above in connection with FIGS. 4 and 5) performed by components of the environment depicted in FIG. 1 to produce various benefits of the implementations described herein. The operations shown in the swim lane diagram performed by a user device (such as one of user device 110A-110N) are shown along the line extending from the box labeled “user device 602,” operations performed by a user identifier (which may be embodied by the distributed application engine 208) are shown along the line extending from the box labeled “user identifier 604,” operations performed by a distributed ledger (such as distributed ledger 116) are shown along the line extending from the box labeled “distributed ledger 606,” operations performed by a metaverse vendor (such as a bank or store operating on a metaverse 120) are shown along the line extending from the box labeled “metaverse vendor 608,” and operations performed by a metaverse 120 are shown along the line extending from the box labeled “metaverse 610.” Operations impacting multiple devices and/or entities, such as data transmissions between the devices, are shown using arrows extending between these lines. Generally, these operations are ordered temporally with respect to one another. However, it will be appreciated that the operations may be performed in other orders from those illustrated in FIG. 6.

At operation 612, the user device 602 may create and transmit input parameters to the user identifier. At operation 614, the user identifier may create an authentication hash from the input parameters. At operation 616, the authentication hash may be returned to the user device for subsequent use. At operation 618, a user may log onto a distributed ledger using the user device 602, and may create a new block on the distributed ledger in operation 620. In operation 622, data from the new block on the distributed ledger may be provided to or accessed by a metaverse vendor, and combined with an authentication hash pushed from a metaverse source in operation 626. In operation 624, the data from the block and the authentication hash from the metaverse source may be combined to verify the passport identity of the user.

FIGS. 4, 5, and 6 illustrate operations performed by apparatuses, methods, and computer program products according to various example embodiments. It will be understood that each flowchart block, and each combination of flowchart blocks, may be implemented by various means, embodied as hardware, firmware, circuitry, and/or other devices associated with execution of software including one or more software instructions. For example, one or more of the operations described above may be embodied by software instructions. In this regard, the software instructions which embody the procedures described above may be stored by a memory of an apparatus employing an embodiment of the present invention and executed by a processor of that apparatus. As will be appreciated, any such software instructions may be loaded onto a computing device or other programmable apparatus (e.g., hardware) to produce a machine, such that the resulting computing device or other programmable apparatus implements the functions specified in the flowchart blocks. These software instructions may also be stored in a computer-readable memory that may direct a computing device or other programmable apparatus to function in a particular manner, such that the software instructions stored in the computer-readable memory produce an article of manufacture, the execution of which implements the functions specified in the flowchart blocks. The software instructions may also be loaded onto a computing device or other programmable apparatus to cause a series of operations to be performed on the computing device or other programmable apparatus to produce a computer-implemented process such that the software instructions executed on the computing device or other programmable apparatus provide operations for implementing the functions specified in the flowchart blocks.

In some embodiments, some of the operations described above in connection with FIGS. 4-6 may be modified or further amplified. Furthermore, in some embodiments, additional optional operations may be included. Modifications, amplifications, or additions to the operations above may be performed in any order and in any combination.

As described above, example embodiments provide methods and apparatuses that enable linking of real-world identities to a digital identity on a distributed ledger that provides a universal passport for the metaverse. By providing this metaverse passport, example embodiments provide tools for consumers to more easily access metaverse services, not only in individual metaverse locations and instances, but by enhancing metaverse interoperability, consumers can carry their identity across multiple metaverses. Example embodiments also provide benefits to businesses providing transactions on the metaverse to reduce the threat of fraudulent transactions by providing a one-to-one identity for user avatars on the metaverse.

### Conclusion

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

1. A method comprising:
receiving, by communications hardware, an indication of user input from a user avatar, the user input comprising a user identification and a set of input parameters associated with the user avatar in a first digital space;
verifying, by a distributed application of a distributed ledger controlled via a distributed application engine, authenticity of the input parameters. wherein the distributed ledger is distinct from the first digital space;
generating, by cryptographic circuitry, an authentication hash of hash components, the hash components comprising the set of input parameters;
transmitting, by the communications hardware, the authentication hash to an authentication entity;
in response to transmitting the authentication hash to the authentication entity, receiving, by the distributed application engine, customer verification data pertaining to a user associated with the user avatar; and
cause, by blockchain circuitry and based on the customer verification data, generation of a block on the distributed ledger, wherein the block comprises the set of input parameters.

2. The method of claim 1, wherein the set of input parameters comprises:
a name of the user avatar;
a type of the user identification;
a user identification number;
a country code; or
a combination thereof.

3. The method of claim 1, wherein the block further comprises the customer verification data.

4. The method of claim 1, wherein the customer verification data comprises:
bank account information;
past transaction information;
a credit score; or
a combination thereof.

5. The method of claim 1, wherein the authentication hash is generated using a SHA-1 algorithm.

6. The method of claim 1, wherein the hash components further comprise a layer-1 hash.

7. The method of claim 6, wherein the block further comprises the layer-1 hash.

8. The method of claim 6, further comprising:
importing, by the distributed application engine, the layer-1 hash from the distributed ledger.

9. (canceled)

10. An apparatus comprising:
communications hardware configured to receive an indication of user input from a user avatar, the user input comprising a user identification and a set of input parameters associated with the user avatar in a first digital space;
a distributed application engine configured to, by controlling a distributed application of a distributed ledger, verify authenticity of the input parameters, wherein the distributed ledger is distinct from the first digital space;
cryptographic circuitry configured to generate an authentication hash of hash components, the hash components comprising the set of input parameters;
wherein the communications hardware is further configured to transmit the authentication hash to an authentication entity;
wherein the distributed application engine is further configured to, in response to transmitting the authentication hash to the authentication entity, receive customer verification data pertaining to a user associated with the user avatar; and
blockchain circuitry configured to generate, based on the customer verification data, a block on the distributed ledger, wherein the block comprises the set of input parameters.

11. The apparatus of claim 10, wherein the set of input parameters comprises:
a name of the user avatar;
a type of the user identification;
a user identification number;
a country code; or
a combination thereof.

12. The apparatus of claim 10, wherein the block further comprises the customer verification data.

13. The apparatus of claim 10, wherein the customer verification data comprises:
bank account information;
past transaction information;
a credit score; or
a combination thereof.

14. The apparatus of claim 10, wherein the authentication hash is generated using a SHA-1 algorithm.

15. The apparatus of claim 10, wherein the hash components further comprise a layer-1 hash provided by the distributed ledger.

16. The apparatus of claim 15, wherein the block further comprises the layer-1 hash provided by the distributed ledger.

17. The apparatus of claim 15, wherein the distributed application engine is further configured to import the layer-1 hash from the distributed ledger.

18. (canceled)

19. A computer program product comprising at least one non-transitory computer-readable storage medium storing software instructions that, when executed, cause an apparatus to:
receive an indication of user input from a user avatar, the user input comprising a user identification and a set of input parameters associated with the user avatar in a first digital space;
verify, by a distributed application of a distributed ledger authenticity of the input parameters, wherein the distributed ledger is distinct from the first digital space;
generate an authentication hash of hash components, the hash components comprising the set of input parameters;
transmit the authentication hash to an authentication entity;
in response to transmitting the authentication hash to the authentication entity, receive customer verification data pertaining to a user associated with the user avatar; and
generate, based on the customer verification data, a block on the distributed ledger, wherein the block comprises the set of input parameters.

20. The computer program product of claim 19, wherein the set of input parameters comprises:
a name of the user avatar;
a type of the user identification;
a user identification number;
a country code; or
a combination thereof.

21-40. (canceled)

41. The method of claim 1, further comprising:
causing, based on the generation of the block on the distributed ledger and using the customer verification data, the first virtual space to conduct a transaction involving the user avatar.
